(19) United States
(12) Patent Application Publication
(10) Pub. No.: US 2021/0079276 A1
(43) Pub. Date: Mar. 18, 2021

(54) POLYURETHANE-BASED ADHESIVE COMPOSITION FOR CONCRETE REINFORCEMENT, AND CONCRETE STRUCTURAL BODY

(71) Applicant: TOYOPOLYMER CO., LTD., Osaka (JP)

(72) Inventor: Akira MURAKAMI, Osaka (JP)

(73) Assignee: TOYOPOLYMER CO., LTD., Osaka (JP)

(21) Appl. No.: 16/613,287

(22) PCT Filed: Apr. 24, 2018
(86) PCT No.: PCT/JP2018/016611

§ 371 Date: Nov. 13, 2019

(30) Foreign Application Priority Data
May 15, 2017 (JP) 2017-096723

(51) Int. Cl. C09J 175/08; B32B 7/12; B32B 13/04

(52) U.S. Cl. CPC C09J 175/08; B32B 13/04; B32B 7/12

(57) ABSTRACT

A polyurethane-based adhesive composition for concrete reinforcement contains a polyol component having at least two hydroxy groups per molecule and a polyisocyanate component having at least two isocyanate groups per molecule. The polyol component includes 70 mass % or more diol in 100 mass % as a total amount of the polyol component. The polyisocyanate component includes 5 mass % or more and 95 mass % or less polymethylene polyphenyl polyisocyanate in 100 mass % as a total amount of the polyisocyanate component.

### TECHNICAL FIELD

The present invention relates to a polyurethane-based adhesive composition for concrete reinforcement and a concrete structural body. This application claims priority based on Japanese Patent Application No. 2017-96723 filed on May 15, 2017, and the entire contents of this Japanese Patent Application are incorporated herein by reference.

### BACKGROUND ART

Concrete is used as a construction material in many circumstances. As a way of reinforcing a concrete member, a method of applying an adhesive on a surface of the concrete member and then winding a belt-shaped reinforcing material thereon, or affixing the material thereto in the form of strips, has been disclosed (see, for example, Patent Literature 1 and Patent Literature 2). This method is applicable, not only to the reinforcement of a newly created concrete member, but also to the reinforcement of an existing member.

### CITATION LIST

### Patent Literature

Patent Literature 1: Japanese Patent Application Laid-Open No. 2014-74264
Patent Literature 2: Japanese Patent Application Laid-Open No. 2011-111865

### SUMMARY OF INVENTION

### Technical Problem

In the above-described method of reinforcing a concrete member using a belt-shaped reinforcing material, the reinforcing material used is made of a highly ductile material, and shows high resistance to tensile force. Further, in the case of a columnar member, winding the reinforcing material around the member adds confining pressure, leading to increased resistance to bending stress and shear force. Further, when the concrete is covered with the reinforcing material, even if the concrete member is partly damaged, the advance of the breakage over the entire member is suppressed and falling off of the member from the surface is prevented.

In order for the belt-shaped reinforcing material to exert its performance, the reinforcing material needs to be fixedly secured to the base material of concrete. An adhesive for bonding the reinforcing material onto the concrete is therefore required to have high adhesive strength. Some adhesives have poor compatibility with the base material of concrete on which the adhesive is applied. When such an adhesive is applied, the base material would likely be broken when the reinforcing material undergoes stress and delaminates from the base material. Some of the adhesives having poor compatibility with the base material of the concrete reduce the strength of the base material, thereby causing breakage of the base material. It is desirable that the adhesive suppresses breakage of the base material of the concrete. Accordingly, the adhesive composition for concrete reinforcement is also required to have good compatibility with the base material after the application thereof.

As explained above, the above-described adhesive is required to have adhesive strength with respect to the concrete that is sufficient for fixedly securing the reinforcing material, and to have good compatibility with the base material of the concrete. An object of the present invention is thus to provide an adhesive composition for concrete reinforcement that has adhesive strength enabling a bonded reinforcing material to exert sufficient reinforcing performance, has good compatibility with a base material of concrete, and contributes to improved earthquake resistance of a concrete member. Another object is to provide a concrete structural body that is excellent in earthquake resistance and highly effective in preventing breakage.

### Solution to Problem

A polyurethane-based adhesive composition for concrete reinforcement of the present application contains a polyol component having at least two hydroxy groups per molecule and a polyisocyanate component having at least two isocyanate groups per molecule. The polyol component includes 70 mass % or more diol in 100 mass % as a total amount of the polyol component. The polyisocyanate component includes 5 mass % or more and 95 mass % or less polymethylene polyphenyl polyisocyanate in 100 mass % as a total amount of the polyisocyanate component.

### Effects of Invention

The present invention is able to provide an adhesive composition for concrete reinforcement that has adhesive strength enabling a bonded reinforcing material to exert sufficient reinforcing performance, suppresses breakage of the base material of concrete, and contributes to improved earthquake resistance of the concrete member, and a concrete structural body that is excellent in earthquake resistance and highly effective in preventing breakage.

### BRIEF DESCRIPTION OF DRAWINGS

FIG. 1 is a schematic perspective view of a concrete structural body.

FIG. 2 is a cross-sectional view of the concrete structural body.

FIG. 3 is a flowchart illustrating steps for producing the concrete structural body.

### DESCRIPTION OF EMBODIMENTS

### Description of Embodiments of the Present Invention

Embodiments of the present invention will be listed and described first. A polyurethane-based adhesive composition for concrete reinforcement according to the present invention contains a polyol component having at least two hydroxy groups per molecule, and a polyisocyanate component having at least two isocyanate groups per molecule. The polyol component includes 70 mass % or more diol in 100 mass % as a total amount of the polyol component. The polyisocyanate component includes 5 mass % or more and 95 mass % or less polymethylene polyphenyl polyisocyanate (hereinafter, also referred to as “polymeric MDI”) in 100 mass % as a total amount of the polyisocyanate component.

The polyurethane-based adhesive composition for concrete reinforcement according to the present invention has the specific composition described above. The polyurethane-based adhesive composition for concrete reinforcement having such a composition has sufficient adhesive force as an adhesive composition for concrete reinforcement, and has good compatibility with the base material. It is thus possible to provide an adhesive composition for concrete reinforcement having adhesive strength suitable for a bonded reinforcing material to exert sufficient earthquake resistance and capable of suppressing breakage of the base material, and to provide a concrete structural body excellent in earthquake resistance.

In the polyurethane-based adhesive composition for concrete reinforcement according to the present invention, the diol may be in an amount of 45 mass % or more and 65 mass % or less in 100 mass % as a total amount of the polyol component and the polyisocyanate component. With the diol included in such a percentage, the polyurethane-based adhesive composition for concrete reinforcement having higher adhesive strength for bonding the reinforcing material to the base material of the concrete can be obtained.

The polyurethane-based adhesive composition for concrete reinforcement according to the present invention may include a first liquid containing the polyol component and a polyisocyanate component including polymethylene polyphenyl polyisocyanate (polymeric MDI), and a second liquid containing the polyol component and a polyisocyanate component not including polymethylene polyphenyl polyisocyanate (polymeric MDI). With this configuration, the polyurethane-based adhesive composition for concrete reinforcement having good coatability can be obtained.

A concrete structural body according to the present invention includes: a base material including concrete; an adhesive layer applied on the base material, the adhesive layer being made of the polyurethane-based adhesive composition for concrete reinforcement described above; and a ductile reinforcing material disposed on the adhesive layer. Such a concrete structural body is excellent in earthquake resistance and highly effective in preventing breakage.

In the concrete structural body according to the present invention, the base material may be a columnar body of reinforced concrete. When the base material is a base material of reinforced concrete, the ductile reinforcing material exerts confining pressure, thereby exerting particularly remarkable reinforcing effect. [Details of Embodiments of the Present Invention]

An embodiment of the polyurethane-based adhesive composition for concrete reinforcement according to the present invention will now be described. The polyurethane-based adhesive composition for concrete reinforcement according to the present embodiment contains a polyol component having at least two hydroxy groups per molecule, and a polyisocyanate component having at least two isocyanate groups per molecule. The polyol component includes 70 mass % or more diol in 100 mass % as a total amount of the polyol component. The polyisocyanate component includes 5 mass % or more and 95 mass % or less polymeric MDI in 100 mass % as a total amount of the polyisocyanate component.

The polyol component includes diol. Diol is a compound, expressed by the general formula: HO—R—OH (where R represents a divalent organic group), having two hydroxy groups in a molecule. Examples of the diol applicable to the polyurethane-based adhesive composition for concrete reinforcement of the present application include: polyether diol, polyester diol, polycarbonate diol, and polymer diol.

Specific examples of the polyether diol include: polyoxyethylene diol, polyoxypropylene diol, polyoxybutylene diol, polyoxymethylene diol, castor oil-modified diol, and epoxy-modified diol. Specific examples of the polyester diol include: polyethylene adipate glycol, polypropylene adipate glycol, polyethylene butylene adipate glycol, and polyneopentyl sebacate glycol. In the polyurethane-based adhesive composition for concrete reinforcement of the present application, one of these diols may be used alone, or two or more diols may be used in combination. Among them, polyoxypropylene diol as one of the polyether diols is preferable. Polyoxypropylene diol is a polyether diol obtained by addition polymerization of propylene oxide to propylene glycol as an initiator.

Examples of the commercially available diols applicable to the polyurethane-based adhesive composition for concrete reinforcement of the present application include: polyether polyols such as ACTCOL® D series (polyoxypropylene diol); polyester diols such as HS 2F-231AS (produced by Hokoku Corporation) and KURARAY POLYOL P series (produced by Kuraray Co., Ltd.); and polycarbonate polyols such as KURARAY POLYOL C series.

The polyol component described above includes 70 mass % or more diol in 100 mass % as a total amount of the polyol component. When the mass of the diol in the polyol component is 70 mass % or more, the composition can exert sufficient adhesive strength as a polyurethane-based adhesive composition for concrete reinforcement. The amount of the diol in the polyol component is preferably 75 mass % or more, more preferably 80 mass % or more, more preferably 85 mass % or more, and particularly preferably 90 mass % or more in 100 mass % as the total amount of the polyol component. The upper limit of the ratio of the polyol component is 100 mass %.

The polyisocyanate component includes polymethylene polyphenyl polyisocyanate (polymeric MDI). Polymeric MDI is a mixture of monomeric MDI (for example, 4,4′-MDI) and polynuclear polyisocyanate. The polymeric MDI includes approximately 35 to 60 mass % monomeric MDI.

Examples of the commercially available polymeric MDIs applicable to the polyurethane-based adhesive composition for concrete reinforcement of the present application include: TOP-100, Millionate® MR (produced by Tosoh Corporation), and Lubranate® M20S (produced by BASF INOAC Polyurethanes Ltd.).

The polyisocyanate component includes 5 mass % or more and 95 mass % or less polymeric MDI in 100 mass % as a total amount of the polyisocyanate component. If the amount of the polymeric MDI in the polyisocyanate component is less than 5 mass %, the adhesive strength will be insufficient as a polyurethane-based adhesive composition for concrete reinforcement. If the amount of the polymeric MDI in the polyisocyanate component exceeds 95 mass %, the compatibility with the base material will be poor. This may cause breakage of the base material upon delamination of the adhesive. With the polymeric MDI included in the polyisocyanate component in an amount of 5 mass % or more and 95 mass % or less in 100 mass % as the total amount of the polyisocyanate component, a polyurethane-based adhesive composition for concrete reinforcement having sufficient adhesive strength and also suppressing breakage of the base material can be obtained. The amount of the polymeric MDI in the polyisocyanate component is preferably 10 mass % or more, and more preferably 20 mass % or more in 100 mass % as the total amount of the polyisocyanate component. The amount is preferably 90 mass % or less, more preferably 80 mass % or less, further preferably 70 mass % or less, and particularly preferably 60 mass % or less.

The polyisocyanate component may include polyisocyanate other than the polymeric MDI. The polyisocyanate included in the polyisocyanate component may be a variety of diisocyanates. Examples of such diisocyanates include:
aromatic diisocyanates such as diphenylmethane-4,4′-diisocyanate (4,4′-MDI), diphenylmethane-4,4′-diisocyanate (2,4′-MDI), 3,3′-dimethyl-4,4′-diphenylmethane diisocyanate, 0-tolidine diisocyanate, 1,4-diphenyl diisocyanate, tolylene diisocyanate (TDI), xylylene diisocyanate (XDI), 1,5-naphthalene diisocyanate (NDI), 1,3-phenylene diisocyanate, 1,4-phenylene diisocyanate, dialkyldiphenylmethane diisocyanate, tetraalkyldiphenylmethane diisocyanate, and α,α,α,α-tetramethylxylylene diisocyanate;
aliphatic diisocyanates such as methylene diisocyanate, ethylene diisocyanate, tetramethylene diisocyanate, hexamethylene diisocyanate (HDI), 2,2,4-trimethylhexamethylene diisocyanate, 2,4,4-trimethylhexamethylene diisocyanate, lysine diisocyanate (LDI), 2-methylpentane-1,5-diisocyanate, and 3-methylpentane-1,5-diisocyanate;
   alicyclic diisocyanates such as isophorone dicyanate (IPDI), 4,4′-dicyclohexylmethane diisocyanate (hydrogenated MDI), 1,4-cyclohexane diisocyanate, methylcyclohexylene diisocyanate (hydrogenated TDI), 1,3-bis(isocyanate methyl)cyclohexane, and norbornene diisocyanate (NBDI); and
polyisocyanate prepolymer obtained by reacting polyol with an excess amount of diisocyanate. As the diisocyanate of the (B) component, one of these diisocyanates may be used alone, or two or more diisocyanates may be used in combination. Among them, diphenylmethane-4,4′-diisocyanate (4,4′-MDI) is preferable which is readily available and highly reactive.

Examples of the commercially available diisocyanates applicable to the polyurethane-based adhesive composition for concrete reinforcement of the present application include: COSMONATE® PH (4,4′-MDI, produced by Mitsui Chemicals, Inc.), Millionate® MT (4,4′-MDI, produced by Tosoh Corporation), COSMONATE® M-100, COSMONATE® M-200 (both produced by Mitsui Chemicals, Inc.), Millionate® MR100, Millionate® MR200 (both produced by Tosoh Corporation), TAKENATE® 500 (xylylene diisocyanate, produced by Mitsui Chemicals, Inc.), TAKENATE® 600 (1,3-bis(isocyanatomethyl)cyclohexane, produced by Mitsui Chemicals, Inc.), TAKENATE® 700 (hexamethylene diisocyanate, produced by Mitsui Chemicals, Inc.), Desmodur® I (isophorone diisocyanate, produced by Sumika Covestro Urethane Co., Ltd.), Desmodur® W (4,4′-dicyclohexylmethane diisocyanate, produced by Sumika Covestro Urethane Co., Ltd.), Coronate® T-100, 80, 65 (tolylene diisocyanate, produced by Tosoh Corporation), and COSMONATE® ND (1,5-naphthalene diisocyanate, produced by Mitsui Chemicals, Inc.).

The diol content is preferably 45 mass % or more and 65 mass % or less in 100 mass % as a total mass of the polyol component and the polyisocyanate component included in the polyurethane-based adhesive composition for concrete reinforcement. The content is more preferably 50 mass % or more, and further more preferably 60 mass % or less. The diol content that is too large or too small impairs the adhesiveness, so the diol content within the above-described range is preferable.

The polyol component described above may include polyol other than diol, such as triol or tetraol. The ratio of the polyol other than the diol in all the polyol included in the polyol component is preferably 30 mass % or less, more preferably 20 mass % or less, further preferably 10 mass % or less, and particularly preferably 5 mass % or less.

The polyurethane-based adhesive composition for concrete reinforcement in the present embodiment may include additive components besides polyol and polyisocyanate. For example, the composition may include, in addition to polyol and polyisocyanate, well-known additives such as a stabilizer, a filler, an adhesion promoter, a curing agent, a curing accelerator, a plasticizer, a thixotropic agent, a pigment, and an antioxidant.

### [Polyurethane-Based Adhesive Composition for Concrete Reinforcement]

The polyurethane-based adhesive composition for concrete reinforcement according to the present embodiment can be produced by homogeneously kneading, in a kneader: diol and polymethylene polyphenyl polyisocyanate (polymeric MDI) described above; polyol other than diol and polyisocyanate other than polymeric MDI added as required; and other necessary additive components. The respective components may be added to the kneader individually. Alternatively, the components may be added as a mixture of a plurality of polyol components, as a mixture of a plurality of polyisocyanate components, or as a mixture of the polyol component and the polyisocyanate component.

The polyurethane-based adhesive composition for concrete reinforcement may be of a two-part type. For example, the composition may include: a first liquid containing the polyol component and a polyisocyanate component including polymeric MDI; and a second liquid containing the polyol component and a polyisocyanate component not including the polymeric MDI. More specifically, the polyurethane-based adhesive composition for concrete reinforcement may include a base polymer A (first liquid) containing diol and 4′4-MDI, and a base polymer B (second liquid) containing diol and polymeric MDI.

### [Concrete Structural Body]

A concrete structural body according to the present embodiment includes: a base material including concrete; an adhesive layer applied on the base material, the adhesive layer being made of the polyurethane-based adhesive composition for concrete reinforcement described above; and a ductile reinforcing material disposed on the adhesive layer.

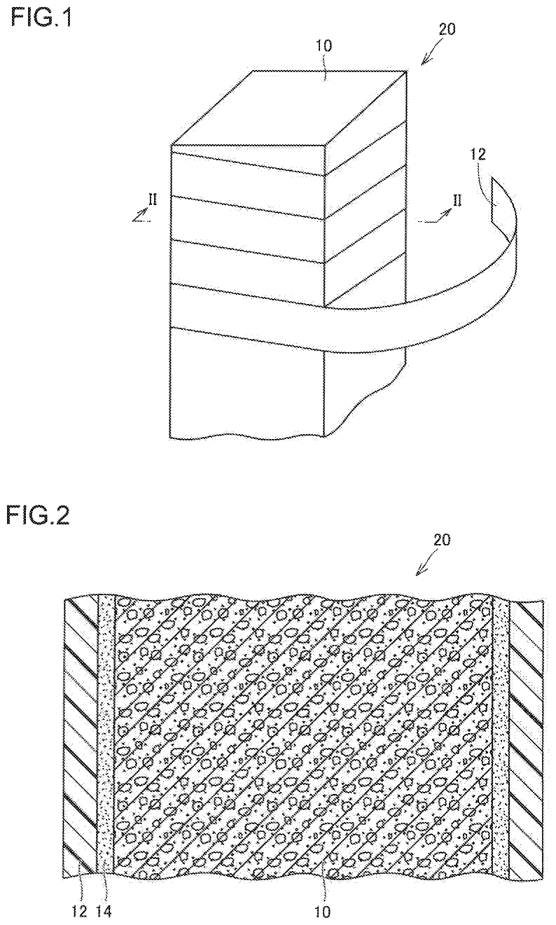

The concrete structural body according to the present embodiment will be described with reference to the drawings. FIG. 1 is a schematic perspective view of a concrete structural body 20. FIG. 2 is a cross-sectional view of the concrete structural body 20. In the present embodiment, a base material 10 is a columnar body of reinforced concrete. Referring to FIG. 1, the base material 10 has a belt-shaped ductile reinforcing material 12 wound thereon. Referring to FIG. 2, the ductile reinforcing material 12 is fixedly secured on the base material 10 via a polyurethane-based adhesive composition 14 for concrete reinforcement as described above.

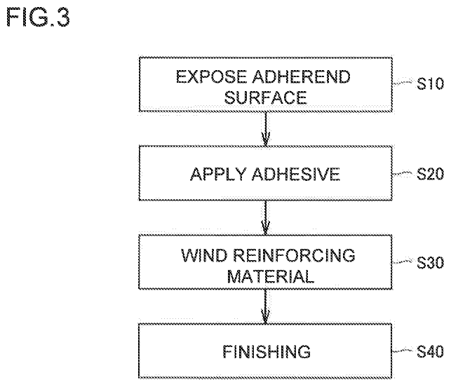

FIG. 3 is a flowchart illustrating steps for producing the concrete structural body 20. Referring to FIG. 3, firstly, a finishing material such as wallpaper affixed to the base material 10 is removed to expose an adherend surface of the base material 10 (step S10; hereinafter, “step” will be omitted). Next, the polyurethane-based adhesive composition 14 for concrete reinforcement is applied to a portion of the exposed adherend surface where the ductile reinforcing material 12 is to be wound (S20). The ductile reinforcing material 12 is wound over the range where the adhesive composition 14 has been applied, without causing sagging (S30). Thereafter, the outer surface of the concrete structural body 20 is subjected to finishing as required (S40). The concrete structural body 20 is thus produced. In the case where the concrete structural body 20 has a shape other than the columnar shape, for example in the case of a wall, the ductile reinforcing material 12 may be affixed thereon over a required range, instead of being wound thereon.

The concrete structural body 20 thus obtained can be used as a member of a building and the like for which earthquake resistance is required.

### EXAMPLES

The present invention will be described more specifically below with reference to examples. However, the scope of the present invention is not to be interpreted as limited by the description of the examples.

Components blended in the inventive examples and comparative examples below are as follows.

### [Polyol]

(1) diol bifunctional PPG (polyoxypropylene diol (polypropylene glycol)), molecular weight: 2,000
(2) triol
trifunctional PPG (polyoxypropylene triol), molecular weight: 3,000

### [Polyisocyanate]

(3) diisocyanate 4,4′-MDI (diphenylmethane-4,4′-diisocyanate)
(4) polymeric MDI (polymethylene polyphenyl polyisocyanate)

### [Additive Components]

PTSI (p-toluenesulfonyl isocyanate)
Reolosil PM-20L (dry silica, produced by Tokuyama Corporation)
WACKER HDK N20 (hydrophilic dry silica, produced by Wacker Asahikasei Silicone Co., Ltd.)
Whiton P-30 (calcium carbonate, produced by Toyo Fine Chemical Co., Ltd.)
KS-1000 (calcium carbonate, produced by Calfine Co., Ltd.)
N Clay (clay, produced by Taisei Sangyo Co., Ltd.)
NYAD-G (wollastonite, produced by NYCO Minerals, Inc.)
Ti Pure R-101 (titanium oxide (IV), produced by DuPont de Nemours, Inc.)

ZEOLUM A-4LPH (hydrophilic zeolite, produced by Tosoh Corporation) Shellsol TK (hydrocarbon-based diluent, produced by Showa Shell Sekiyu K.K.) IP SOLVENT 1620 (hydrocarbon-based diluent, produced by Idemitsu Kosan Co., Ltd.) EMBILIZER OL-1 (dioctyltin dilaurate, produced by Tokyo Fine Chemicals Co., Ltd.) UCAT-660M (2,2′-dimorpholinoethyl ether, produced by San-Apro Ltd.)

### [Preparation of Polyurethane-Based Adhesive Composition for Concrete Reinforcement]

Polyurethane-based adhesive compositions for concrete reinforcement were prepared by introducing components into a kneader and homogenously kneading them, on the basis of the formulations shown in Table 1. Table 2 shows the ratios of bifunctional PPG, trifunctional PPG, 4,4′-MDI, and polymeric MDI within the polyurethane-based adhesive compositions for concrete reinforcement, calculated on the basis of the formulations in Table 1.

### [Evaluation of Adhesive Strength and Interface Delamination Energy]

Adhesive strength was evaluated under the following conditions. On a ductile reinforcing material SRF 100 (width: 30 mm×length: 100 mm×thickness: 1.1 mm), an adhesive composition to be evaluated was applied, using a combing trowel for tile bonding conforming to JIS A 5548, to achieve an application quantity of 1,150 to 1,200 g/m². Thereafter, the ductile reinforcing material with the adhesive applied was affixed to a base material (mortar plate or slate plate (width: 50 mm×length: 100 mm×thickness: 10 mm)) to achieve a bonded area of 30 mm×50 mm. Then, the layered body affixed to the base material was fixedly secured by clipping and clamped, and cured in this state for three days under the conditions of room temperature (of 20 to 25° C.) and 30 to 60% RH. The cured test samples were subjected to measurement of shear bond strength under the condition of tension rate of 5 mm/min. The measurement was conducted on test samples of the number of samples: n=3. Following the measurement, bond strength and surface delamination energy were calculated for the three test samples in accordance with the following expressions. Further, m-3a was also obtained by subtracting three times their standard deviation σ from their mean value m.

The adhesive strength τ_{fave} was obtained from the following expression.

$${τ}_{fave} = \frac{P}{{b}_{f} \times w} \qquad [ Math . 1 ]$$

The interface delamination energy Gf was obtained in accordance with the following expression.

$${G}_{f} = \frac{{t}_{f}}{2 {E}_{f}} \times {( {σ}_{f} )}^{2} = \frac{{t}_{f}}{2 {E}_{f}} {( \frac{P}{{t}_{f} \times w} )}^{2} \qquad [ Math . 2 ]$$

where P: maximum tensile load, bf: bonded length (50 mm), w: bonded width (30 mm), t_{f}: thickness of SRF 100 (1.1 mm), E_{f}: effective Young's modulus of SRF 100 (1,400 N/mm²), and σ_{f}: stress occurring on SRF 100. Evaluation results are shown in Table 2.

TABLE 1

| | | Inventive Examples | | | | | | | Comparative Examples | | |
|---|---|---|---|---|---|---|---|---|---|---|---|
| | | 1 | 2 | 3 | 4 | 5 | 6 | 7 | 1 | 2 | 3 |
| Polyol | Bifunctional PPG | 64.5 | 61.2 | 59.7 | 58.1 | 54.3 | 54.3 | 52.6 | 39.6 | 31.8 | 67.7 |
| | Trifunctional PPG | 0 | 0 | 0 | 0 | 0 | 0 | 0 | 21.42 | 0 | 0 |
| Polyisocyanate | 4,4′-MDI | 28.2 | 24.1 | 22.0 | 20.0 | 22.0 | 22.0 | 20.0 | 29.0 | 0.0 | 32.3 |
| | Polymeric MDI | 7.3 | 14.6 | 18.3 | 21.9 | 23.7 | 23.7 | 27.3 | 10.0 | 68.1 | 0.0 |
| Additive | PTSI | 2 | 2 | 2 | 2 | 3 | 2 | 2 | 1.7 | 3.4 | 2 |
| Components | Reolosil PM-20L | 8 | 8 | 8 | 8 | 8 | 8 | 8 | 2.5 | 6 | 8 |
| | WACKER HDK N20 | | | | | | | | 1.5 | | |
| | Whiton P-30 | 98 | 98 | 98 | 98 | 98 | 98 | 98 | | | |
| | KS-1000 | | | | | | | | 150 | 180 | |
| | N Clay | | | | | | | | | | 57.05 |
| | NYAD-G | | | | | | | | | | 24.45 |
| | Ti Pure R-101 | | | | | | | | | | 7.5 |
| | ZEOLUM A-4LPH | | | | | | | | | | 9 |
| | Propylene Carbonate | 7 | 7 | 7 | 7 | 7 | 7 | 7 | 5 | 5 | 7 |
| | Shellsol TK | | | | | 8 | | | 8 | 9 | |
| | IP SOLVENT 1620 | 7 | 7 | 7 | 7 | | 7 | 7 | | | 7 |
| | EMBILIZER OL-1 | | | | | | | | | 0.03 | |
| | UCAT-660M | 0.02 | 0.02 | 0.02 | 0.02 | 0.02 | 0.02 | 0.02 | 0.02 | | 0.22 |
| | TOTAL | 279.52 | 279.52 | 279.52 | 279.52 | 281.52 | 279.52 | 279.52 | 268.72 | 323.43 | 279.72 |

TABLE 2

| | | Inventive Examples | | | | | | | Comparative Examples | | |
|---|---|---|---|---|---|---|---|---|---|---|---|
| | | 1 | 2 | 3 | 4 | 5 *1) | 6 | 7 | 1 *1) | 2 *1) | 3 |
| Polyol | Bifunctional | 64.5 | 61.2 | 59.7 | 58.1 | 54.3 | 54.3 | 52.6 | 39.6 | 31.8 | 67.7 |
| (PO) | PPG | | | | | | | | | | |
| | Trifunctional | 0 | 0 | 0 | 0 | 0 | 0 | 0 | 21.42 | 0 | 0 |
| | PPG | | | | | | | | | | |
| Poly- | 4,4′-MDI | 28.2 | 24.1 | 22.0 | 20.0 | 22.0 | 22.0 | 20.0 | 29.0 | 0.0 | 32.3 |
| isocyanate | Polymeric MDI | 7.3 | 14.6 | 18.3 | 21.9 | 23.7 | 23.7 | 27.3 | 10.0 | 68.1 | 0.0 |
| Component | Diol/ | 64.5 | 61.3 | 59.7 | 58.1 | 54.3 | 54.3 | 52.7 | 39.5 | 31.8 | 67.7 |
| Ratio | (PO + | | | | | | | | | | |
| | Polyisocyanate) | | | | | | | | | | |
| | (mass %) | | | | | | | | | | |
| | Diol/Entire PO | 100.0 | 100.0 | 100.0 | 100.0 | 100.0 | 100.0 | 100.0 | 64.9 | 100.0 | 100.0 |
| | (mass %) | | | | | | | | | | |
| | Polymeric | 20.57 | 37.7 | 45.4 | 52.3 | 51.8 | 51.8 | 57.7 | 25.7 | 100.0 | 0.0 |
| | MDI/Entire | | | | | | | | | | |
| | Polyisocyanate | | | | | | | | | | |
| | (mass %) | | | | | | | | | | |
| Adhesive | Mean Adhesive | 2.146 | 2.276 | 2.429 | 2.466 | 2.578 | 2.535 | 2.634 | 2.042 | 2.119 | 1.953 |
| Strength | Strength *2) | | | | | | | | | | |
| Evaluation | | | | | | | | | | | |
| | m-3σ | 1.695 | 1.681 | 2.032 | 1.498 | 2.233 | 2.163 | 2.008 | 1.379 | 1.913 | 1.579 |
| | Interface | 2.274 | 2.563 | 2.909 | 3.028 | 3.276 | 3.169 | 3.430 | 2.067 | 2.212 | 1.883 |
| | Delamination | | | | | | | | | | |
| | Energy *2) | | | | | | | | | | |
| | m-3σ | 1.337 | 1.216 | 1.975 | 0.764 | 2.390 | 2.229 | 1.820 | 0.731 | 1.787 | 1.159 |
| | Fracture Mode | Cohesive | Cohesive | Cohesive | Cohesive | Cohesive | Cohesive | Cohesive | Cohesive | Breakage | Cohesive |
| | | Failure | Failure | Failure | Failure | Failure | Failure | Failure | Failure | of Base | Failure |
| | | | | | | | | | | Material | |
| | Evaluated Rank | B | B | A | B | S | S | A | F | F | F |

*1) For Inventive Example 5 and Comparative Examples 1 and 2, mortar was used as a base material for bonding the reinforcing material thereto. For the other examples, a slate plate was used as the base material.
*2) Mean adhesive strength is in N/mm², and Interface delamination energy is in N/mm.

### [Consideration on Evaluation Results]

The adhesive strength was evaluated in accordance with the following criteria.

Rank F (Fail)

when one of the following three criteria is satisfied: (1) the adhesive strength is less than 2.1 N/mm², (2) the interface delamination energy is less than 2.2 N/mm, and (3) the dominant fracture mode is breakage of the base material.

Rank B (Acceptable level)

when the following three conditions are all satisfied: (1) the adhesive strength is 2.1 N/mm² or more, (2) the interface delamination energy is 2.2 N/mm or more, and (3) the dominant fracture mode is cohesive failure of the adhesive.

Rank A (Pass level)

when the conditions for the rank B are satisfied and, additionally, (4) the value of (m−3σ) of the adhesive strength is 2.0 N/mm² or more.

Rank S (Excellent level)

when the conditions for the rank A are satisfied and, additionally, (5) the value of (m−3σ) of the interface delamination energy is 2.0 N/mm or more.

As shown in Table 2, the polyurethane-based adhesive compositions for concrete reinforcement in Inventive Examples 1 to 7 all exhibited high values of adhesive strength of 2.1 N/mm² or more and interface delamination energy of 2.2 N/mm or more. In all of them, the dominant fracture mode was cohesive failure of the adhesive. It has thus become apparent that the polyurethane-based adhesive compositions for concrete reinforcement in Inventive Examples 1 to 7 have properties suitable as the polyurethane-based adhesive composition for concrete reinforcement. Particularly, Inventive Examples 3 and 5 to 7 were ranked S or A, where the value of (m−3σ) of the mean adhesive strength was 2.0 N/mm² or more. Further, in Inventive Examples 5 and 6, the value of (m−3σ) of the interface delamination energy was 2.0 N/mm or more. These results demonstrate that a suitable polyurethane-based adhesive composition for concrete reinforcement having high adhesive strength and causing no breakage of the base material upon delamination of the adhesive can be obtained in the range where the polyol component includes 100 mass % diol (bifunctional PPG) in 100 mass % as a total amount of the polyol component and the polyisocyanate component contains 20.57 mass % or more and 57.7 mass % or less polymeric MDI in 100 mass % as a total amount of the polyisocyanate component.

In contrast, the adhesive composition of Comparative Example 1 containing trifunctional PPG, where the ratio of the bifunctional PPG, i.e. diol, to the entire polyol component was 64.9 mass %, and that of Comparative Example 3 containing no polymeric MDI were both insufficient in adhesive strength as compared to the adhesive compositions of the inventive examples.

Although Comparative Example 2 including a large amount of polymeric MDI exhibited adhesive strength comparable to those of the inventive examples, there occurred breakage of the base material. Breakage of a base material would likely occur when the adhesive strength of the adhesive is greater than the strength of the base material. However, the value of the adhesive strength was similar to those of the inventive examples. This is presumably because, in Comparative Example 2, the strength of the base material decreased due to the adhesive applied to the surface of the base material of concrete. It was thus confirmed that the adhesive used in Comparative Example 2 had poor compatibility with the base material of the concrete.

The results of the above examples have revealed that the polyurethane-based adhesive composition for concrete reinforcement in the present embodiment has physical properties suitable for an adhesive composition for concrete reinforcement that has adhesive strength enabling a bonded reinforcing material to exert sufficient reinforcing performance, suppresses breakage of the base material of concrete, and improves earthquake resistance of the concrete member.

It should be understood that the embodiment and examples disclosed herein are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

The polyurethane-based adhesive composition for concrete reinforcement of the present application is applicable particularly advantageously in the technical field where there is a demand for an adhesive composition for concrete reinforcement that has adhesive strength enabling a bonded reinforcing material to exert sufficient reinforcing performance, suppresses breakage of a base material of concrete, and improves earthquake resistance of a concrete member.

### REFERENCE SIGNS LIST

10: base material; 12: ductile reinforcing material; 14: polyurethane-based adhesive composition for concrete reinforcement; and 20: concrete structural body.

1: A polyurethane-based adhesive composition for concrete reinforcement, containing:
a polyol component having at least two hydroxy groups per molecule and a polyisocyanate component having at least two isocyanate groups per molecule;
the polyol component including 70 mass % or more diol in 100 mass % as a total amount of the polyol component,
the polyisocyanate component including 5 mass % or more and 95 mass % or less polymethylene polyphenyl polyisocyanate in 100 mass % as a total amount of the polyisocyanate component.

2: The polyurethane-based adhesive composition for concrete reinforcement according to claim 1, wherein the diol is in an amount of 45 mass % or more and 65 mass % or less in 100 mass % as a total amount of the polyol component and the polyisocyanate component.

3: The polyurethane-based adhesive composition for concrete reinforcement according to claim 1, including
a first liquid containing the polyol component and a polyisocyanate component including polymethylene polyphenyl polyisocyanate, and
a second liquid containing the polyol component and a polyisocyanate component not including polymethylene polyphenyl polyisocyanate.

4: A concrete structural body comprising:
a base material including concrete;
an adhesive layer applied on the base material, the adhesive layer being made of the polyurethane-based adhesive composition for concrete reinforcement according to claim 1; and
a ductile reinforcing material disposed on the adhesive layer.

5: The concrete structural body according to claim 4, wherein the base material is a columnar body of reinforced concrete.
